(19) United States
(12) Patent Application Publication
(10) Pub. No.: US 2005/0200205 A1
(43) Pub. Date: Sep. 15, 2005

(54) On-site power generation system with redundant uninterruptible power supply

(76) Inventors: David W. Winn, Lafayette, CA (US); Alfredo H. Hernandez, San Jose, CA (US); Gary D. Carr, Walnut Creek, CA (US)

Correspondence Address: COCHRAN FREUND & YOUNG LLC, 2026 CARIBOU DR, SUITE 200, FORT COLLINS, CO, 80525, US

(21) Appl. No.: 11/048,621

(22) Filed: Jan. 31, 2005

Related U.S. Application Data
(60) Provisional application No. 60/540,800, filed on Jan. 30, 2004.

(51) Int. Cl. H02P 11/00; H02K 7/02; H02J 9/00

(52) U.S. Cl. 307/64; 363/19; 700/287; 322/4; 322/39

(57) ABSTRACT

Disclosed is a method and system for providing constant critical AC electrical load with primary, secondary, and in some cases a tertiary source of power with higher reliability and lower operating and capital costs and lower emissions than the traditional utility supply, uninterruptible power supply (UPS), and battery primary power source, and diesel generator back-up systems that are predominately used today. Specifically, the disclosed system utilizes on-site power generation to provide primary power and includes full utility and UPS/DC storage back-up systems.

### CROSS REFERENCE TO RELATED APPLICATIONS

The present application is based upon and claims the benefit of U.S. Provisional Patent Application Ser. No. 60/540,800 by David W. Winn, et al., entitled “On-Site Power Generation System with Redundant Uninterruptible Power Supply” filed Jan. 30, 2004, the entire contents of which is hereby specifically incorporated by reference for all it discloses and teaches.

### BACKGROUND OF THE INVENTION

1. Field of the Invention

The present invention relates to on-site power generation and more specifically to a system that provides full time primary electrical load with multiple redundant backup capability.

2. Description of the Background

Critical facilities within various financial, information, industrial and military applications require power that is not subject to loss or substantial variability on a continuous, or 24 hour per day, 7 days per week duty cycle. Large-scale computer information systems, databases, control centers, automated equipment and machinery that are in continuous operation may call for AC power that is not influenced by perturbations caused by outside demands, power grid limitations or distribution inadequacies. These “mission critical” facilities currently rely on local utility companies and power grid infrastructure for primary power and must compensate for deficiencies of service with redundant uninterruptible power supplies, batteries and diesel generators. This widely employed approach results in high cost, sub-optimal reliability, and excessive damage to the environment.

### SUMMARY OF THE INVENTION

The present invention overcomes the disadvantages and limitations of the prior art by providing constant critical AC electrical load using on-site power generation to provide primary power other energy storage back-up systems.

The present invention may therefore comprise an electrical power generation system comprising: an on-site primary power source that supplies primary power to a primary generator bus; a primary output distribution switchboard that receives the primary power from the primary generator bus and distributes the primary power to a static-switch; a secondary power source that supplies secondary power to an input distribution bus; a secondary output distribution switchboard for receiving the secondary power from the input distribution bus that distributes the secondary power to the static-switch, the static-switch that switches power sources from the primary power source to the secondary power source in the event of a failure of the primary power source; a synchronization control that monitors and compares frequencies and voltage phase angles of the primary power and the secondary power and synchronizes the primary power source and the secondary power source; an energy storage backup system to provide short-term power that enables the secondary power source to be initiated and synchronized into a distributed power grid; and, a power distribution unit that receives power from the static-switch and distributes electrical power to an electrical demand.

The present invention may also comprise a method of providing electrical power comprising: supplying primary power to a primary generator bus with an on-site primary power source; receiving the power from the primary power source with a primary output distribution switchboard; distributing the primary power source from the primary output distribution switchboard to a static-switch; supplying secondary power to an input distribution bus with a secondary power source; receiving the secondary power from the input distribution bus with a secondary output distribution switchboard; distributing the secondary power source from the secondary output distribution switchboard to the static-switch; switching from the primary power source to the secondary power source in the event of a failure of the primary power source with the static-switch; monitoring and comparing frequencies and voltage phase angles of the primary power and the secondary power to synchronize the primary power source with the secondary power source; providing short-term power with an energy storage backup system that enables the secondary power source to be initiated and synchronized into a distributed power grid; receiving electrical power from the static-switch with a power distribution unit; and, distributing the electrical power to an electrical demand.

### BRIEF DESCRIPTION OF THE DRAWINGS

In the drawings,

FIG. 1 is a schematic block diagram of an embodiment of an on-site power generation system that incorporates a redundant power source with back-up power supply.

FIG. 2 is a schematic block diagram of an embodiment of an on-site power generation system that incorporates secondary and tertiary back-up power.

FIG. 3 is a mechanical flow diagram of an embodiment of efficient utilization of thermodynamic byproducts of an on-site power generation system with redundant power source and back-up power supply.

### DETAILED DESCRIPTION OF THE INVENTION

While this invention is susceptible to embodiment in many different forms, there is shown in the drawings and will be described herein in detail specific embodiments thereof with the understanding that the present disclosure is to be considered as an exemplification of the principles of the invention and is not to be limited to the specific embodiments described.

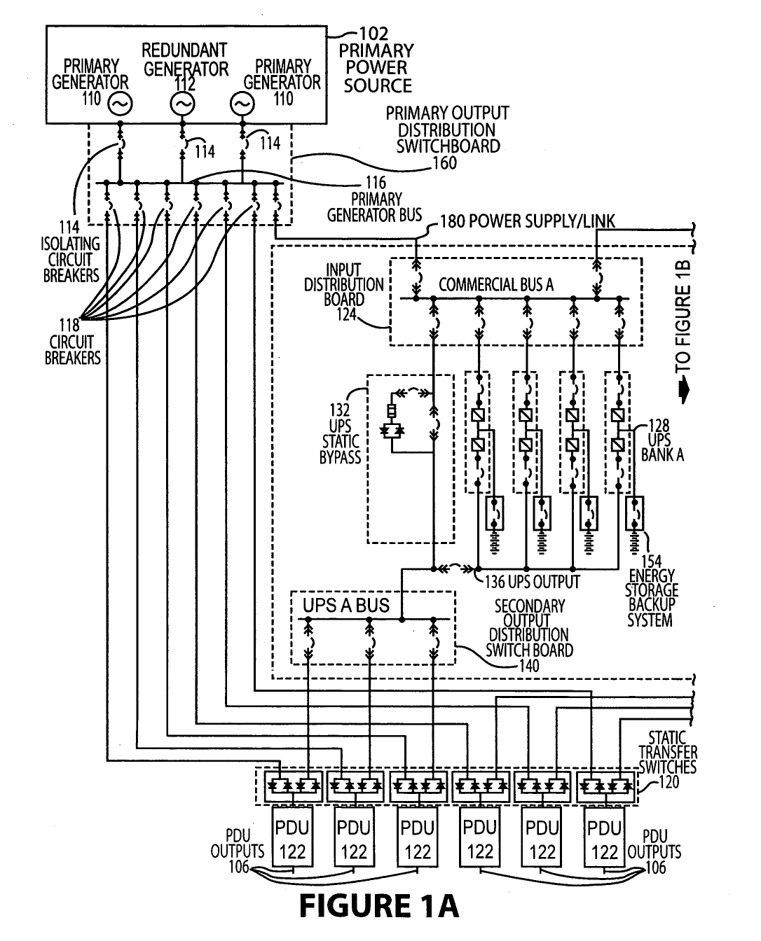

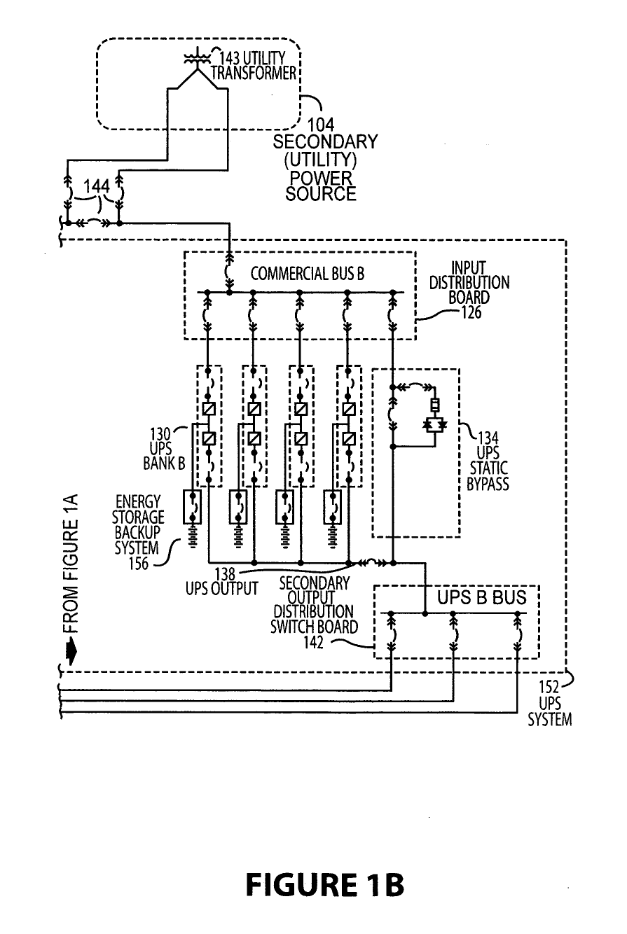

FIG. 1 illustrates an embodiment of an on-site power generation system that incorporates a redundant power source with back-up power supply. As illustrated in FIG. 1, the primary power source 102 in this embodiment comprises two primary generators 110 and redundant generator 112. The primary generators 110 and redundant generators 112 may take a wide variety of form including natural gas reciprocating engines, dual fuel diesel/natural gas fired engines, natural gas fired turbines, natural gas fired micro turbines, fuel cells or the like. The power from the source is typically generated anywhere between 480V and 13.8 kV, delivered to a primary output distribution switchboard 160 containing isolating circuit breakers 114, and transformed as necessary and delivered through a primary generator bus 116 with circuit breakers 118 at 480V.

From the primary output distribution switchboard 160, the electricity is delivered through isolating switches to the dual-fed power distribution units (PDUs) 122 on the data center floor or other demand sites within the mission critical facility. The dual-fed PDU 122 possesses a static-switch 120 capable of switching power sources within 4 ms and within an AC input voltage boundary which can be tolerated (no interruption in function) by most Information Technology Equipment (ITE) as described by ITI (CBEMA) Curve. ITI is an acronym for Industry Technology Industry Council (formerly known as the Computer & Business Equipment Manufacturer's Association). Each PDU 122 has an internal transformer to further reduce the 480V power down to 120/208 V and is capable of delivering a nominal 225 kVA of power to the data center ITE through PDU outputs 106 and one primary generator may deliver power to a primary side of multiple PDUs 122 on the data center floor.

The secondary (utility) source 104 or back-up power system is sourced from the utility through an interconnection to the facility. The utility interconnect will consist of a transformer 143, circuit breakers 144, and metering equipment (not shown). In most cases, the utility entrance voltage will be 4160 kV or below, however in some of the larger facilities, utility power is delivered at 13.8 kV, 21 kV, or even 66 kV. Once inside the facility, power is distributed through 480V switchgear to the input distribution boards 124 and 126, to the uninterruptible power supply (UPS) modules 128 and 130, and to the primary output distribution switchboard 160. The power supply/link 180 from either input distribution board 124 or 126 serves as another redundant backup to the primary and redundant generators, and in some configurations, is operated in parallel with the utility power source 104 in order to accommodate certain conditions of loading. Static or rotary UPS modules 128 and 130 ensure that the utility power is delivered with a clean waveform, and a connected battery string or a rotary flywheel energy storage backup system 154-156 will provide the short term power required to enable other generators or another power source to be started-up and synchronized into the distributed power grid. The static or rotary UPS system 152 can be designed to offer the client the capacity to have full redundancy to the capacity of the primary power facility. The UPS system 152 can have the full capacity of the primary power source 102 with the inclusion of additional systems to provide n+1 redundancy, or the UPS system 152 can be designed to only back-up one of the primary power sources 110-112. The UPS system 152 can also be run with an engine generator/motor and clutch system or the like.

Energy storage back-up systems 154-156 are connected into the UPS system 152 to provide the short-term power required during a utility outage. Energy storage back-up duration depends on reliability requirements and the load of the facility vs. the design capacity of the entire UPS system 152. Typical durations for an energy storage back-up system 154 provide sustainable power for 15 to 45 minutes. Typical durations for a rotary flywheel energy storage device that produces DC power similar to batteries provide sustainable power for 15 seconds.

The static or rotary UPS system 152 is also designed as a conditioner for the back-up power provided by the utility or by the back-up diesel generators. The UPS system 152 ensures that the utility power is delivered within ITI (CBEMA) curve voltage boundaries with frequency variations limited to ±1%, and free of transient pulses, line noise, and interruption. The UPS system 152 consists of solid-state AC to DC rectifier/battery charger, DC storage battery or a rotary flywheel energy storage and solid-state DC to AC inverter, and provides both the power conditioning and short-term power storage for the utility power when utility back-up power is required. The UPS system 152 takes in utility AC power and feeds the rectifier, converting the AC wave to DC. The DC rectifier float charges the battery bank or rotates a rotary flywheel energy storage and provides the DC power to the inverter which transforms the DC power back into a clean sinusoidal AC power wave. The AC output power from the UPS system 152 is then distributed to the PDU 122 and ultimately to the critical loads, via static transfer switch 120, if it is called upon in the event of loss of primary on-site generated power. Some rotary UPS systems consist of a motor/generator combination connected to both a flywheel energy storage device and a reciprocating engine. These systems do not include batteries and utilize the stored energy in the flywheel to supply approximately 15 seconds of power to the ITE through a DC to AC inverter. During the 15 seconds, the engine starts and an integral clutch activates and the engine to supply power to the motor/generator.

Should the utility power also fail coincident with a primary power source outage, the back-up battery or flywheel storage device within the UPS system 152 provides power via the UPS outputs 136-138 and distributed through UPS busses 140-142 to serve the PDUs 122. The back-up battery will typically provide 20 to 40 minutes of back-up power, and a flywheel storage device will typically provide 15 seconds of back-up power, which is enough time to start up either a back-up diesel engine generator or a natural gas fired primary power engine generator. In the event of a failure within the UPS system 152, a momentary overload, or required system maintenance, an internal static electronic by-pass switch 132 and 134 will by-pass the UPS rectifier/inverter and provide the utility power to the output of the UPS system 152 and thus to the PDUs 122 directly. The UPS system 152 has synchronizing circuitry to assure that the UPS inverter output and the UPS by-pass source are in synchronism so that in the event of a UPS fault, the by-pass switch can close without any interruption of power to the loads supplied by the UPS output 136-138.

The PDUs 122 have two electrical inputs, one from the primary power source 102 and the other from secondary power source 104 and/or the UPS system 152 as the alternate source. These two input sources are connected to the distribution panels of the PDU 122 through the static transfer switches 120. The 122 feeds the PDU loads under normal conditions. In the event of problem with the primary power source 102, the static transfer switches 120 will seamlessly transfer to the alternate power source.

From the secondary output distribution switchboard of the UPS 140 and 142, the electricity is delivered through isolating switches to the dual-fed PDUs 106 on the data center floor. The dual-fed PDU 106 possesses a static transfer switch 120 capable of switching power sources within 4 ms and within an AC input voltage boundary which can tolerated (no interruption in function) by most (ITE) as described by ITI (CBEMA) and a transformer to further reduce the 480V power sources down to nominal use voltage for the ITE. Each PDU 122 is capable of delivering a PDU output 106 at a nominal 225 kVA of power to the ITE and one set of UPS modules will deliver power to the secondary side of multiple PDUs 106 and then to the ITE located at the data center.

The power from the on-site generation equipment in the primary power source 102 is synchronized through controls, which maintain synchronization between the on-site generation equipment and the utility/UPS output power. The auto-synchronization controls (not shown) will continually monitor and compare the frequencies and voltage phase angles of the two sources to assure absolute synchronization. If the back-up utility power is available and the primary generators become asynchronous with the power from the utility/UPS system, the power feed will be seamlessly transferred from the primary on-site power source to the back-up utility power source through the PDU static switches.

As mentioned above, power switching between the on-site primary power source 102 and the secondary power source 104 is accomplished through an electronic static transfer switch 120 (STS). The STS 120 monitors the quality of the primary and secondary power sources 102 and 104, and in the event of an interruption in the primary power source 102, or if the primary power quality goes out of specification, the will make a non-break transfer to the backup supply within ¼ cycle. This high speed switching time prevents any interruption of power to the critical load. The STS 120 is typically located at the PDU 122, however it can also be located in other areas of the system depending on the configuration utilized for the particular installation.

In static transfer switches, solid-state electronic devices are used to perform the transition function from one power source to another. Though these switches execute an open-circuit “break-before-make” transfer, due to their fast acting switching characteristics (4 ms or less) these switches effectively provide what appears to be a closed transition to the loads without actually connecting the two sources in electrical parallel operation.

For the primary power generators 110-112, paralleling controls are used to ensure that engine generators can be operated together (electrically paralleled) to deliver the necessary power to the loads and to share the load between components of the primary power source 102. In some configurations, the primary power generators 110-112 are operated in parallel with the utility power source 104 in order to accommodate certain conditions of loading. For the diesel generators, paralleling controls are also used so that power can be seamlessly delivered between a utility or back-up power source and a diesel generator back up when using the diesel generator for testing or for carrying the load if the primary power generators need to be shutdown for some reason. The generator controls are microprocessor-based, integrating operator interface to the digital voltage regulation, digital governing, and generator set protective functions.

To synchronize the primary generators 110-112 of the on-site primary power source 102, one generator will be designated as the lead generator to establish the common bus and the other generators that are in operation will be then synchronized and paralleled to that bus. To keep the on-site primary power generators 110-112 in synchronism with the secondary utility source 104 and the UPS system 152, the controls utilize a signal taken from the UPS output 136 (which itself is synchronized to the utility source) and is used to synchronize the lead generator such that the generator output voltage, frequency and electrical phase relationship is matched to the output of the UPS system 152. This synchronization takes place without the actual physical electrical parallel operation of the primary generators and the UPS system 152. Automatic synchronization is used to synchronize the two sources. These automatic synchronizers monitor voltages and compare frequency and phase of the voltages being monitored. The speed and output voltage of the primary power generators 110-112 is adjusted as necessary by the automatic synchronizer such that the generators are maintained in synchronism with the UPS system 152.

When the primary power source 102 is delivering power to the data center floor, waste heat may be generated from the combustion and mechanical processes. Waste heat may be captured from the exhaust of the primary engine(s) in a hot water or steam boiler and from the engine jacket and lube oil cooling water. Water may be pumped through metal tubes exposed to the hot exhaust gases, heated, and delivered to the generator section of an absorption or adsorption chiller. The chiller may then use this heat to vaporize refrigerant from either a liquid brine solution or a solid silica compound. This may provide a driving force to ultimately produce chilled water for delivery to the data center floor. The chilled water can then be delivered to the computer room air conditioning (CRAC) units on the data center floor. The heated return water from the chiller condenser is delivered a cooling tower to be evaporatively cooled so that it can be reintroduced into the adsorbption or absorption process.

Additionally, embodiments may utilize a primary power source for efficient use of other energy within the system to serve mission critical facility requirements. This system may comprise a primary power generator, a utility electricity entrance, static or rotary uninterruptible power supply (UPS) with battery or rotary flywheels energy storage systems, diesel generator(s), heat driven chillers, dual-fed power distribution units (PDU)'s, and parallel and redundant medium and low voltage electrical distribution systems.

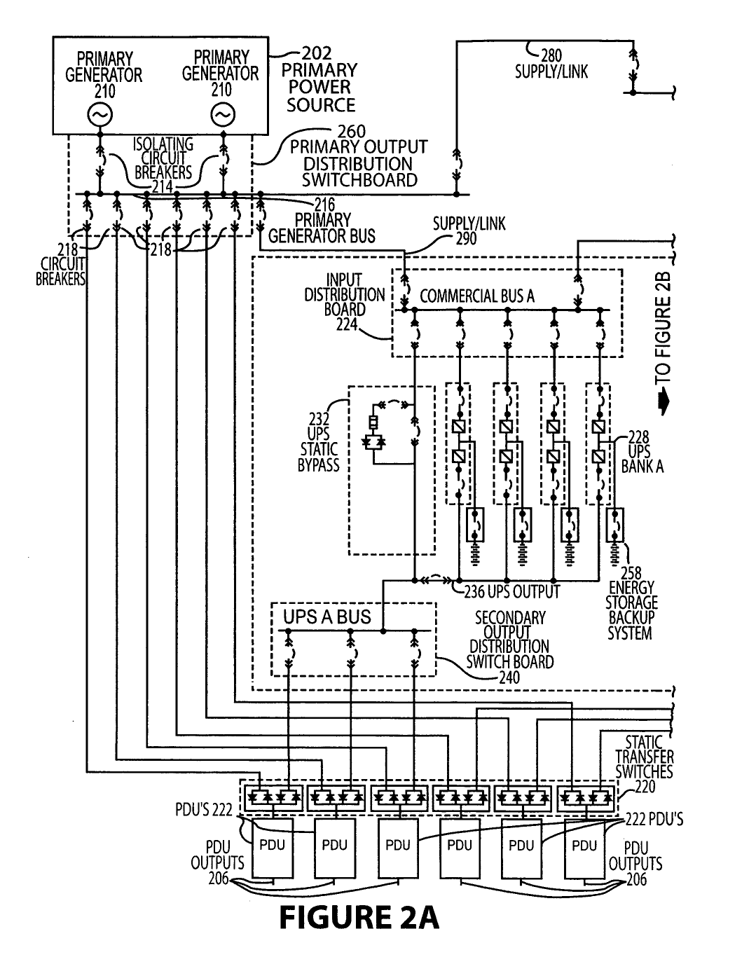

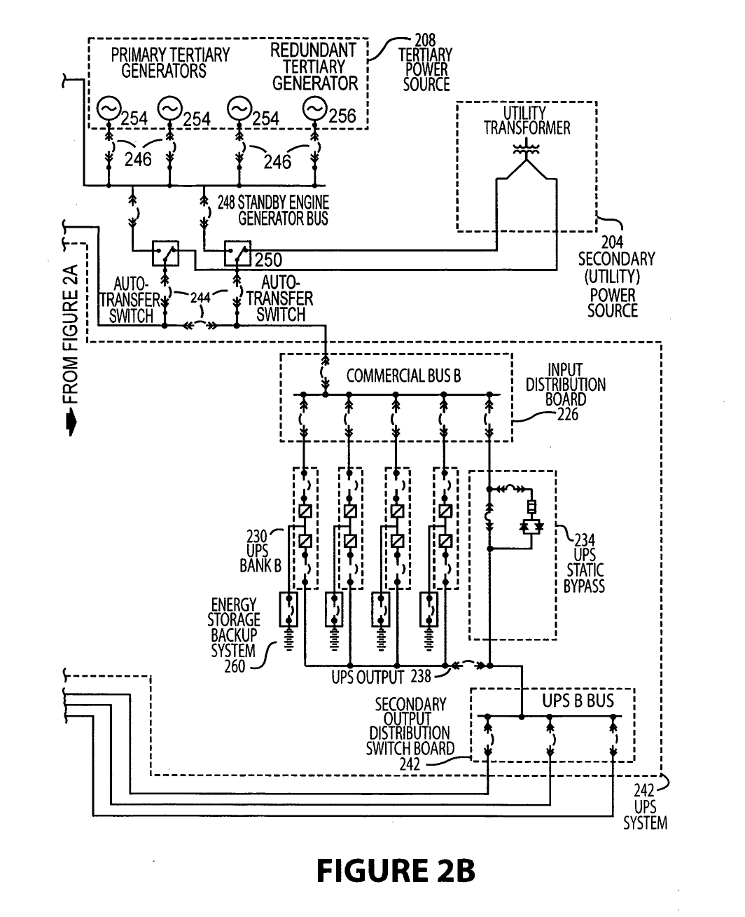

FIG. 2 illustrates an embodiment of an on-site power generation system that incorporates secondary and tertiary back-up power. As illustrated in FIG. 2, the primary power source 202 in this embodiment comprises two primary generators 210. The power from the source is delivered to a primary output distribution switchboard 260 containing isolating circuit breakers 214, and transformed as necessary and delivered through a primary generator bus 216 with circuit breakers 218. From the primary output distribution switchboard 260, the electricity is delivered through isolating switches to the dual-fed power distribution units (PDUs) 222 on the data center floor. The dual-fed PDU possesses a static-switch 220 capable of switching power sources within the 4 ms and a transformer to further reduce the 480V power sources down to 120/208V. Each PDU is capable of delivering a nominal 225 kVA of power to the data center floor through PDU outputs 206 and one primary generator will deliver power to a primary side of multiple PDUs 222 at the data center.

The secondary (utility) source 204 or back-up power system is sourced from the utility through an interconnection to the facility. The utility interconnect will consist of a transformer 243, circuit breakers 244, and metering equipment (not shown). Once inside the facility, power is distributed through 480V switchgear and input distribution boards 224 and 226 to the uninterruptible power supply (UPS) modules 228 and 230.

UPS modules 228 and 230 are connected to an energy storage backup system 258-260, such as a battery string or a rotary flywheel energy storage device, to provide the short-term power. As with the embodiment demonstrated in FIG. 1, the UPS system 252 can have the full capacity of the primary power source 202 with the inclusion of additional systems to provide n+1 redundancy, or the UPS system 252 can be designed to only back-up one of the primary power sources 210.

From the secondary output distribution switchboard of the UPS 240 and 242, the electricity is delivered through isolating switches to the dual-fed PDUs 206 on the data center floor. The dual-fed PDU 206 possesses a static transfer switch 220 capable of switching power sources within 4 ms and within an AC input voltage boundary which can tolerated (no interruption in function) by most ITE as described by ITI (CBEMA) Curve and a transformer to further reduce the 480V power sources down to nominal use voltage for the ITE. Each PDU 222 is capable of delivering a PDU output 206 at a nominal 225 kVA of power to the data center floor and one set of UPS modules will deliver power to the secondary side of multiple PDUs 206 at the data center.

Should the secondary (utility) power source 204 fail, the tertiary back-up 208, in some cases is an existing generator plant, is brought on-line to supply power. The primary tertiary generators 254 and redundant tertiary generators 256 are tied into the UPS input distribution boards 224-226 and feed through the secondary side electrical distribution system. The primary tertiary generators 254 and redundant tertiary generators 256 are designed with synchronizing controls and transfer switches that allow for a closed transition of load from the utility 204 or energy storage backup system 258-260 (typically a DC storage source of power) within the UPS system 252 to the primary tertiary generators 254 and redundant tertiary generators 256. The system controls are set such that the utility/DC storage power and generator sources can run together for approximately 200 ms before the utility/DC storage source is disconnected. The intentional delay allows for any residual voltage due to inductive load to sufficiently decay before connecting to another power source. This delay will prevent potentially damaging voltage and current transients in the on-site power systems.

If a failure were also to occur to the tertiary back-up 208 coincident with a primary power source outage and a utility outage, the back-up DC storage within the UPS system 252 provides power via the UPS outputs 236-238 and distributed through UPS busses 240-242 to serve the PDUs 222. If a failure were to occur with one or both of the primary generators 210, the power supply/link 280 from the standby engine-generator bus 248 is used to supply power form the standby diesel generators 254 to the primary output distribution switchboard 260.

Similar to FIG. 1, this configuration can also include a power supply/link 290 from either input distribution board 224 or 226 and supply power to the primary output distribution switchboard 260. The power supply/link 290 from either input distribution board 224 or 226 serves as another redundant backup to the primary and redundant generators, and in some configurations, is operated in parallel with the utility power source 204 in order to accommodate certain conditions of loading. As with the embodiment of FIG. 1, the UPS system 242 can also be run with an engine generator/motor and clutch system or the like.

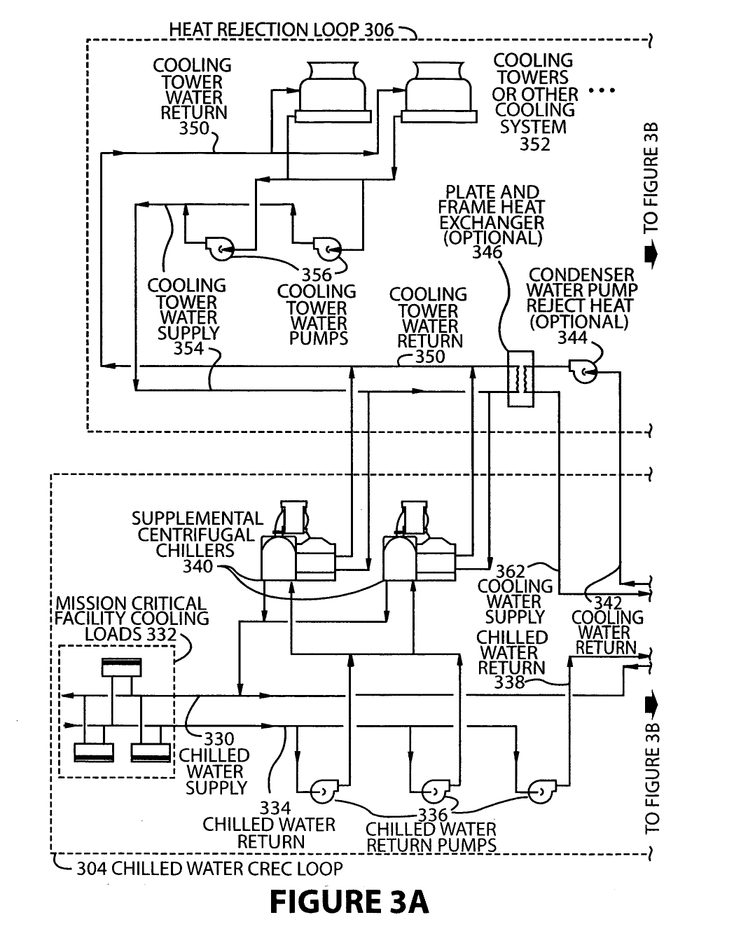

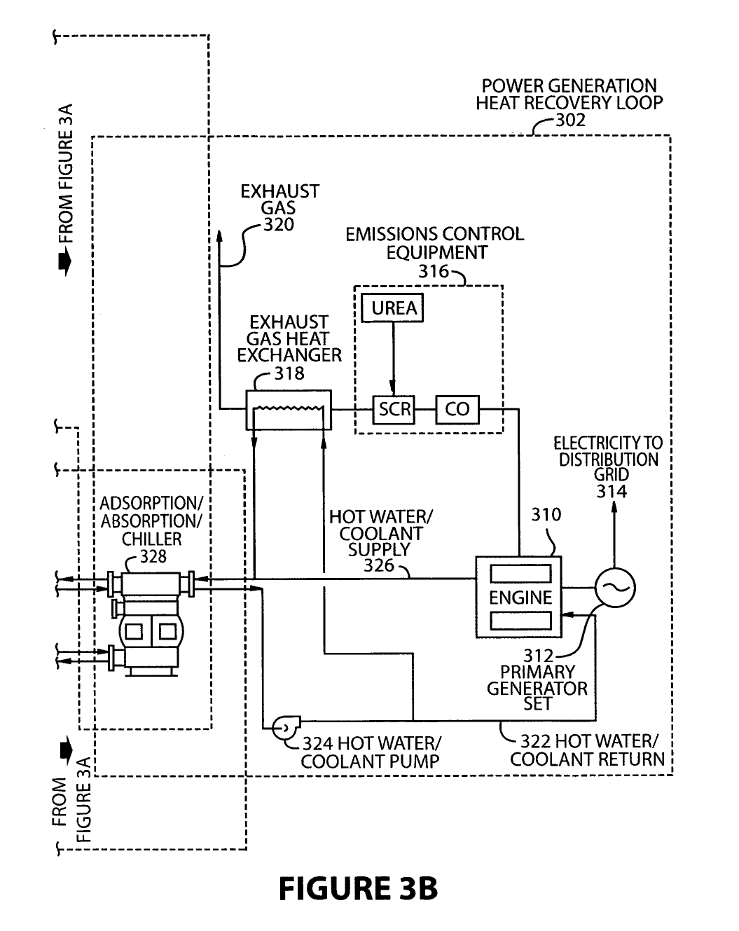

FIG. 3 is a mechanical flow diagram of an embodiment detailing efficient utilization of thermodynamic byproducts of an on-site power generation system with redundant power source and back-up power supply. A primary drawback of conventional small power generation equipment is due to efficiency limitations of the available technology. To ultimately compete against the pricing of utility power that is generated with large, high efficiency power plants, the waste heat of the small on-site generator must be used to reduce energy consumption. In mission critical applications, with high-density power requirements, an accompanying large chilling load is also required. The on-site power generation system may utilize the waste heat from the primary power source to produce chilled water with either absorption or adsorption chilling technology.

The disclosed system may therefore utilize the primary power waste heat in an efficient manner to substantially reduce the electricity used to cool the traditional mission critical data center either through central water-cooled mechanical chilling or air-cooled roof top units. Any primary power technology that is utilized in the system will provide waste heat at a level such that it can be utilized to generate cooling. The system may utilize either adsorption or absorption chillers to capture and convert the waste heat into useful cooling. Typical reduction in facility power use from this method is 0.65 kW/ton-hr up to 1.3 kW/ton-hr of useful chilling provided by the heat recovery chillers.

When the primary generator from FIGS. 1 and 2 are delivering power to the data center floor, waste heat is being generated from the combustion and mechanical processes. This waste heat can be captured in a hot water or steam boiler and from the engine jacket and lube oil cooling water. Water can be used in combination with an absorption or adsorption chiller that uses the heat to vaporize the refrigerant from either a liquid brine solution or a solid silica compound. This provides the driving force to ultimately produce chilled water for delivery to the data center floor. The chilled water can be delivered to the computer room air conditioning (CRACs) units on the data center floor. The heated return water from the chiller condenser can be delivered the cooling tower to be evaporatively cooled so that it can be reintroduced into the adsorbption or absorption process.

As illustrated in FIG. 3, three primary closed loop heat exchange systems, a power generation heat recovery loop 302, a chilled water CRAC loop 304, and heat rejection loop 306, may combine with the on-site power generation system disclosed in FIGS. 1 and 2 to provide a highly reliable, highly efficient system for on-site power generation. The power generation heat recovery loop 302 is driven by an engine 310 powering a primary generator 312 to create electricity for a distribution grid utilized by mission critical facility. Byproduct exhaust from engine 310 is fed through emission control equipment 316 to lower toxic emissions and then fed through exhaust gas heat exchanger 318 to recover heat before the exhaust gas 320 is expelled to the atmosphere. Cool return water from the absorption/adsorption chiller 328 is circulated with coolant pump 324 via a water coolant return line 322 to cool engine 310 and then returned via hot water/coolant supply 326 to the absorption/adsorption chiller 328. Exhaust gas heat exchanger 318 is tied into hot water/coolant supply line 326 and is used to draw heat from the exhaust gas 320 and return it to the system.

The chilled water CRAC loop 304 utilizes a chilled water return line 334 from the absorption/adsorption chiller 328 to supply the mission critical facility cooling loads 332. The water then returns to the absorption/adsorption chiller 328 via chilled water return line 334 driven by chilled water return pumps 336. The chilled water return pumps 336 also create a secondary loop to supplemental centrifugal chillers 340 to assisting cooling providing additional mission critical facility cooling loads 332 that are also introduced through chilled water supply 330.

The heat rejection loop 306 also interfaces with the power generation heat recovery loop 302 and the chilled water CRAC loop 304 at the absorption/adsorption chiller 328. Reject heat is expelled from the absorption/adsorption chiller 328 through cooling water return line 342 in the form of hot water and is pumped through a plate and frame heat exchanger 346 with a reject heat condenser water pump 344. Reject heat water is transferred to cooling towers or other cooling systems 352 via cooling tower water return lines 350 and plate and frame heat exchanger 346 via cooling tower water supply lines 354 driven by cooling tower water pumps 356. The heat rejection loop 306 also dissipates waste heat from supplemental centrifugal chillers 340 by expelling heat through water return line 350 and receives cooling via cooling tower water supply 354.

The absorption chiller is particularly appropriate in cooling applications where there is a low-pressure steam or hot liquid source, a waste heat recovery option, or in areas where electric rates or demand charges are high. A typical single-stage absorption chiller is designed to use steam at pressures up to 14 psig and at temperatures to 340° F., or hot water at temperatures up to 270° F. These chillers are ideal for delivering chilled water at temperatures ranging between 42° F. and 50° F.

In the absorption cycle, steam or hot water is used to boil a dilute solution of lithium bromide and water in a hermetic vessel known as the generator. The water vapor produced from this boiling in the generator is drawn through a condenser, where it gives up heat to the cooling tower water, and the resultant condensed water is then sprayed into an evaporator chamber in which an extreme vacuum exists. As this condensate water, which is the refrigerant, is sprayed into the evaporator around the evaporator tube bundle, it absorbs heat from the chilled water, which is flowing inside of tubes of the evaporator tube bundle. Due to the extreme vacuum of the evaporator chamber, the refrigerant water boils at 39° F. The boiling of the refrigerant allows it to transfer a large quantity of heat per pound of refrigerant from the chilled water circulating through the evaporator tubes into the refrigerant. The extreme vacuum in the evaporator is maintained by the hygroscopic action of the strong lithium bromide solution, which is being sprayed into the absorption chamber directly below the evaporation chamber. The strong lithium bromide solution, which has been regenerated by boiling off the water in the generator vessel, actually pulls the refrigerant vapor into solution, creating the extreme vacuum in the evaporator. The absorption of the refrigerant vapor into the lithium bromide also creates heat, which is removed by the cooling water. The resultant diluted lithium bromide solution is pumped to the generator where the refrigerant water is boiled-off to regenerate it and the two solutions are then routed back to their respective chambers to continue the refrigeration cycle.

The adsorption chiller contains only water as a refrigerant and a permanent silica gel as an adsorbent. The evaporator section of the adsorber cools the chilled water by the refrigerant (water) being evaporated under an extreme vacuum in the evaporator chamber. The resultant refrigerant vapor is routed to an adsorption chamber and is adsorbed onto the silica gel in the chamber. Once the silica gel has adsorbed a given quantity of refrigerant vapor, it is isolated from its evaporation chamber and regenerated by passing hot water through a tube bundle within the silica gel chamber. The adsorption chiller contains two independent evaporator chambers and two adsorption chambers. One of the evaporator/adsorption chamber pairs is in the cooling mode while the other is in the regeneration mode. These two chamber pairs switch modes once every several minutes. The water vapor, which is driven-off of the silica gel in the regenerating adsorption chamber, is condensed by cooling water and is pumped to the evaporation chamber of the pair that is in the cooling mode. The adsorption chiller is capable of producing chilled water at temperatures below 38° F., utilizing hot water temperatures ranging from 194° F. to as low as 122° F.

The disclosed systems can further improve the environmental impacts of a mission critical facility. Elimination of the need to operate or even install diesel generator back-up systems will substantially reduce the potential emission of nitrous oxides (NOx), carbon monoxide (CO), and particulate emissions at the facility. The primary power source designed into the on-site power generation system will burn cleaner natural gas or not require combustion of any gases when used with a fuel cell, and also possesses all of the back-end clean up equipment required to meet the most stringent Best Available Control Technologies called for by the local air districts. Finally, the on-site power generation system will require substantially fewer battery strings for support of fewer UPS. This will reduce the amount of lead-acid batteries that ultimately have to be disposed of in landfills and that have to be fabricated in manufacturing plants.

The disclosed systems, therefore, may provide a clean, reliable, inexpensive source of primary power that is completely controlled at the facility. An on-site primary power source producing critical power to a primary bus and distribution system, synchronized with but independent from a back-up utility secondary bus and distribution system facilitates this objective. Additionally, the embodiments provide a reliable, inexpensive, and simple system to supply short-term and long-term power supply to back-up the primary source of power. The short-term power back up will be met with a combination of utility and UPS/battery back-up providing power through fast-acting switches at the PDU. Upon loss of primary power, switches will immediately provide power from the utility back-up source. Static or rotary UPS and DC storage back-up systems will provide power quality and short-term power should there be a further desire or need to provide a tertiary source of power. Depending on the reliability requirements, the UPS/DC storage back up can be sized either for the full generation capability of the primary power source or the largest component of generation in the primary power plant. In either case, the UPS/DC storage combination of a traditional parallel/redundant (2n or 2×(n+1)) UPS design is cut in half, saving valuable floor space and investment capital.

The systems also allow for additional power reliability when required by various applications. Tertiary back up in the form of on-site generators or an additional primary power component may provide n+1 redundancy to the primary power generation. If the tertiary back up consists of diesel generation, the power will flow through the secondary or utility side of the distribution system. Should the tertiary back up be provided by an n+1 primary power source, the power is delivered through the primary power distribution system.

A further advantage of the disclosed system is the reduction of energy inefficiencies of the traditional mission critical UPS design. The on-site power generation system design relegates the UPS to a stand-by mode, with only a small trickle charge being lost to the DC storage bank. The traditional UPS design flows power through very lightly loaded UPS system resulting in high energy inefficiencies across the UPS.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. An electrical power generation system comprising:
an on-site primary power source that supplies primary power to a primary generator bus;
a primary output distribution switchboard that receives said primary power from said primary generator bus and distributes said primary power to a static-switch;
a secondary power source that supplies secondary power to an input distribution bus;
a secondary output distribution switchboard for receiving said secondary power from said input distribution bus that distributes said secondary power to said static-switch, said static-switch that switches power sources from said primary power source to said secondary power source in the event of a failure of said primary power source;
a synchronization control that monitors and compares frequencies and voltage phase angles of said primary power and said secondary power and synchronizes said primary power source and said secondary power source;
an energy storage backup system to provide short-term power that enables said secondary power source to be initiated and synchronized into a distributed power grid; and,
a power distribution unit that receives power from said static-switch and distributes electrical power to an electrical demand.

2. An electrical power generation system of claim 1, wherein said on-site primary power source is comprised of at least one primary generator.

3. An electrical power generation system of claim 1, wherein said on-site primary power source is comprised of at least one primary generator and at least one redundant generator.

4. An electrical power generation system of claim 1, wherein said primary output distribution switchboard contains circuit breakers that isolates connections between said primary power source and said static-switch.

5. An electrical power generation system of claim 1 further comprising:
a power supply/link connection that connects said primary generator bus to said input distribution bus.

6. An electrical power generation system of claim 1, wherein said secondary power source is a utility transformer.

7. An electrical power generation system of claim 1, wherein said energy storage backup system is a DC battery.

8. An electrical power generation system of claim 1, wherein said energy storage backup system is a rotary flywheel.

9. An electrical power generation system of claim 1, wherein said energy storage backup system is a rotary uninterruptible power supply with DC battery.

10. An electrical power generation system of claim 1, wherein said energy storage backup system utilizes a fast start engine generator.

11. An electrical power generation system of claim 1 further comprising:
a transfer switch connected to said secondary power source and a tertiary power source at a transfer switch input and connected to said input distribution bus with a transfer switch output, said transfer switch that switches power sources from said secondary power source to said tertiary power source in the event of a failure of said secondary power source.

12. An electrical power generation system of claim 11, wherein said tertiary power source is comprised of at least one primary tertiary generator.

13. An electrical power generation system of claim 12, wherein said at least one primary tertiary generator is a diesel generator.

14. An electrical power generation system of claim 11, wherein said tertiary power source is comprised of at least one primary tertiary generator and at least one redundant tertiary generator.

15. An electrical power generation system of claim 14, wherein said at least one redundant tertiary generator is a diesel generator.

16. An electrical power generation system of claim 11, wherein said synchronization control monitors and compares frequencies and voltage phase angles of said secondary power and said tertiary power and synchronizes said secondary power source and said tertiary power source.

17. A method of providing electrical power comprising:
supplying primary power to a primary generator bus with an on-site primary power source;
receiving said power from said primary power source with a primary output distribution switchboard;
distributing said primary power source from said primary output distribution switchboard to a static-switch;
supplying secondary power to an input distribution bus with a secondary power source; receiving said secondary power from said input distribution bus with a secondary output distribution switchboard;
distributing said secondary power source from said secondary output distribution switchboard to said static-switch;
switching from said primary power source to said secondary power source in the event of a failure of said primary power source with said static-switch;
monitoring and comparing frequencies and voltage phase angles of said primary power and said secondary power to synchronize said primary power source with said secondary power source;
providing short-term power with an energy storage backup system that enables said secondary power source to be initiated and synchronized into a distributed power grid;
receiving electrical power from said static-switch with a power distribution unit; and,
distributing said electrical power to an electrical demand.

18. An electrical power generation system of claim 17, wherein said step of supplying primary power to a primary generator bus with an on-site primary power source further comprises:
supplying said primary power with said on-site primary power source comprised of at least one primary generator.

19. An electrical power generation system of claim 17 further comprising the step of:
supplying said primary power with said on-site primary power source comprised of at least one primary generator and at least one redundant generator.

20. An electrical power generation system of claim 17, wherein said step of supplying secondary power to an input distribution bus with a secondary power source further comprises:
supplying said secondary power with a utility transformer.

21. An electrical power generation system of claim 17 further comprising the step of:
isolating connections between said primary power source and said static-switch with at least one circuit breaker.

22. An electrical power generation system of claim 17 further comprising the step of:
connecting said primary generator bus to said input distribution bus with a power supply/link.

23. An electrical power generation system of claim 17, wherein said step of providing short-term power with an energy storage backup system that enables said secondary power source to be initiated and synchronized into a distributed power grid further comprises:
supplying said short-term power with an energy storage backup system that is comprised of at least one DC battery.

24. An electrical power generation system of claim 17, wherein said step of providing short-term power with an energy storage backup system that enables said secondary power source to be initiated and synchronized into a distributed power grid further comprises:
supplying said short-term power with an energy storage backup system that is comprised of at least one rotary flywheel.

25. An electrical power generation system of claim 17, wherein said step of providing short-term power with an energy storage backup system that enables said secondary power source to be initiated and synchronized into a distributed power grid further comprises:
supplying said short-term power with an energy storage backup system that is comprised of a rotary uninterruptible power supply with DC battery.

26. An electrical power generation system of claim 17, wherein said step of providing short-term power with an energy storage backup system that enables said secondary power source to be initiated and synchronized into a distributed power grid further comprises:
supplying said short-term power with an energy storage backup system that utilizes a fast start engine generator.

27. An electrical power generation system of claim 17 further comprising the step of:
supplying tertiary power with a tertiary power source and said secondary power from said secondary power source to a transfer switch that switches power from said secondary power source to said tertiary power source in the event of a failure of said secondary power source;
receiving said tertiary power from said transfer switch with said input distribution bus;
receiving said tertiary power from said input distribution bus with said secondary output distribution switchboard;
distributing said tertiary power source from said secondary output distribution switchboard to said static-switch.
monitoring and comparing frequencies and voltage phase angles of said secondary power and said tertiary power to synchronize said secondary power source with said tertiary power source; and,
providing short-term power with said energy storage backup system that enables said tertiary power source to be initiated and synchronized into said distributed power grid.

28. An electrical power generation system of claim 27, further comprising the step of:
supplying said tertiary power with said tertiary power source comprised of at least one primary tertiary generator.

29. An electrical power generation system of claim 27, further comprising the step of:
supplying said tertiary power with said tertiary power source comprised of at least one primary tertiary generator and at least one redundant tertiary generator.

30. A system for increasing efficiency of an electrical power generation array with redundant power source and back-up power supply comprising:
a power generation heat recovery loop comprising:
a primary generator driven by an engine that produces electric power;
a heat exchanger that extracts engine heat from said engine
an adsorption/absorption chiller that uses said engine heat to vaporize refrigerant and produce chilled water;
a chilled water loop comprising:
a cooling tower that cools heated return water from said adsorption/absorption chiller to produce chilled water;
a cooling load that utilizes said chilled water to produce environmental cooling;
a heat rejection loop comprising:
a cooling water return line that receives reject heat expelled from said absorption/adsorption chiller; and,
a cooling system that cools said reject heat and returns cool water to said absorption/adsorption chiller.

31. A system of claim 30, wherein said power generation heat recovery loop further comprises:
emission control equipment to reduce toxic emissions of said engine.

32. A system of claim 30, wherein said cooling tower is a centrifugal chiller.

33. A system of claim 30, wherein said cooling system is an evaporative cooling tower.

34. A method of increasing efficiency of an electrical power generation array with redundant power source and back-up power supply comprising:
producing electric power with a primary generator driven by an engine;
producing heat with said engine;
extracting engine heat from said engine with a heat exchanger;
vaporizing refrigerant with an adsorption/absorption chiller to produce chilled water;
cooling heated return water from said adsorption/absorption chiller with a cooling tower to produce chilled water;
producing environmental cooling of a cooling load by utilizing said chilled water;
receiving reject heat expelled from said absorption/adsorption chiller with a cooling water return line;
cooling said reject heat with a cooling system; and,
returning cool water to said absorption/adsorption chiller.

35. A method of claim 34 further comprising the step of:
reducing the toxic emissions of said engine with emission control equipment.

36. A system for providing electrical power comprising:
means for supplying primary power to a primary generator bus with an on-site primary power source;
means for receiving said power from said primary power source with a primary output distribution switchboard;
means for distributing said primary power source from said primary output distribution switchboard to a static-switch;
means for supplying secondary power to an input distribution bus with a secondary power source;
means for receiving said secondary power from said input distribution bus with a secondary output distribution switchboard;
means for distributing said secondary power source from said secondary output distribution switchboard to said static-switch;
means for switching from said primary power source to said secondary power source in the event of a failure of said primary power source with said static-switch;
means for monitoring and comparing frequencies and voltage phase angles of said primary power and said secondary power to synchronize said primary power source with said secondary power source;
means for providing short-term power with an energy storage backup system that enables said secondary power source to be initiated and synchronized into a distributed power grid;
means for receiving electrical power from said static-switch with a power distribution unit; and,
means for distributing said electrical power to an electrical demand.
